(19) United States
(12) Patent Application Publication
(10) Pub. No.: US 2018/0060850 A1
(43) Pub. Date: Mar. 1, 2018

(54) Integrated Changing Room Management System

(71) Applicant: Alert Tech, Inc., Houston, TX (US)

(72) Inventor: Brian Laney, Seabrook, TX (US)

(21) Appl. No.: 15/686,881

(22) Filed: Aug. 25, 2017

Related U.S. Application Data
(60) Provisional application No. 62/379,560, filed on Aug. 25, 2016.

(51) Int. Cl. G06Q 20/20; G06Q 10/08

(52) U.S. Cl. CPC G06Q 20/203; H04W 88/08; G06Q 20/202; G06Q 10/087

(57) ABSTRACT

An integrated changing room system is disclosed. The system includes sensors for sensing the presence and attributes of customers utilizing changing rooms within a retail store. The system integrates, presence, occupancy, movement, and merchandise data, facilitating the retailer's ability to enhance the customers' experience. The system includes one or more sensors integrated with one or more servers.

### CROSS REFERENCE TO RELATED APPLICATIONS

This is a non-provisional application of U.S. Patent Application Ser. No. 62/379,560, filed Aug. 25, 2016, to which priority is claimed, and which is incorporated by reference in its entirety.

### FIELD OF THE INVENTION

The present application relates to systems and methods for improving customer experiences and sales in a clothing retail store. More specifically, the application relates to an integrated system for facilitating the use of a changing room in a retail store and capturing analytical data related to the use.

### BACKGROUND

Brick and mortar retailers (BMRs) are constantly challenged to improve customer experience and employee competency to maximize their competiveness. BMRs increasingly rely on analytics and metrics to help them achieve those goals. As stores become more network driven, new opportunities for the collection and analysis of metrics open up. For example, a BMR may attempt to analyze data derived from security cameras to determine how shoppers move about a store and may also try to correlate that data to sales (a.k.a. conversions), based on data obtained from point of sale (POS) systems. Networking a BMR's security and POS systems together facilitates such an analysis.

Clothing BMRs have realized that conversion rates for shoppers who utilize the fitting rooms to try on apparel are much greater than the conversion rates of customers who don't. Thus, there is a need in the art for systems and methods to integrate changing room usage data into retailer analytics.

### BRIEF DESCRIPTION OF THE DRAWINGS

FIG. 1 shows a network of a BMR enterprise.

FIG. 2 shows components of an integrated changing room system (ICRS).

FIG. 3 shows the logical configuration of an ICRS server.

FIG. 4 is a table showing correlations and actionable data obtained from an ICRS.

FIGS. 5A and 5B show a use case for a ICRS.

### DESCRIPTION

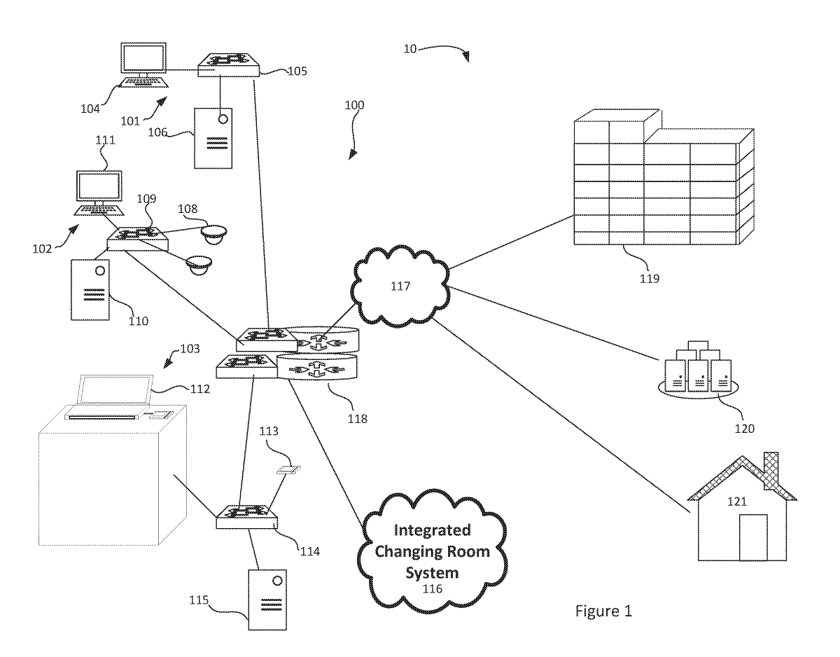

FIG. 1 shows an example network 10 of a BMR, focusing on a local area network (LAN) 100 within a single store. Appreciate that many different network configurations/topologies are possible and the illustrated store LAN 100 is simply one example. Also appreciate that components of the store LAN 100, such as firewalls, hubs, and the like, are omitted for clarity. Connections between networked entities can generally be wired or wireless, unless specifically stated. The store LAN 100 can include one or more subnetworks. Note that the term subnetwork is used herein to denote logical groups of networked resources, irrespective of how those logical groups are realized. In other words, the term subnetwork is used broadly herein to refer to both formal subnets, which are typically implemented at the third layer of the Open Systems Interconnection model (OSI model) and to other methods of segmenting networked resources, such as virtual local area networks (VLANs), which are layer two constructs. A person of skill in the art appreciates that many methods exist for network zoning and can choose an appropriate method, any of which are referred to herein as subnetworking.

The illustrated store LAN 100 includes a management subnetwork 101, a security subnetwork 102 and a subnetwork 103. The illustrated management subnetwork 101 may include one or more manager workstations 104, one or more switches 105, and one or more 106 management servers 107. The illustrated security subnetwork 102 includes security cameras 108, switch 109, security server 110, and workstation(s) 111. The illustrated POS subnetwork 103 includes a fixed POS 112, a mobile POS 113, a switch 114, and a POS server 115. The illustrated network 100 also includes an integrated changing room subnetwork 116, which will be discussed in more detail below. The integrated changing room subnetwork 116 is abbreviated herein as ICRS for brevity. Moreover, integrated changing room subnetwork and integrated changing room system are used interchangeably, with “system” used more frequently herein after.

The store LAN 100 can connect to the internet 117 through a system 118 of one or more switches and routers, referred to herein as the communications subnetwork 118. The communications subnetwork 118 may also direct communication among the management, security, POS, and ICRS subnetworks and other networked store resources. Being connected to the internet 117, the communications subnetwork 118 or other resources of the store LAN 100 can connect to other members of the BMR enterprise, such as a home office 119 or one or more data centers 120. As discussed in more detail below, information derived from one or more of the store LAN resources may also be provided to consumers 121, typically via the home office 119, the data center 120, or another website hosting entity (not illustrated).

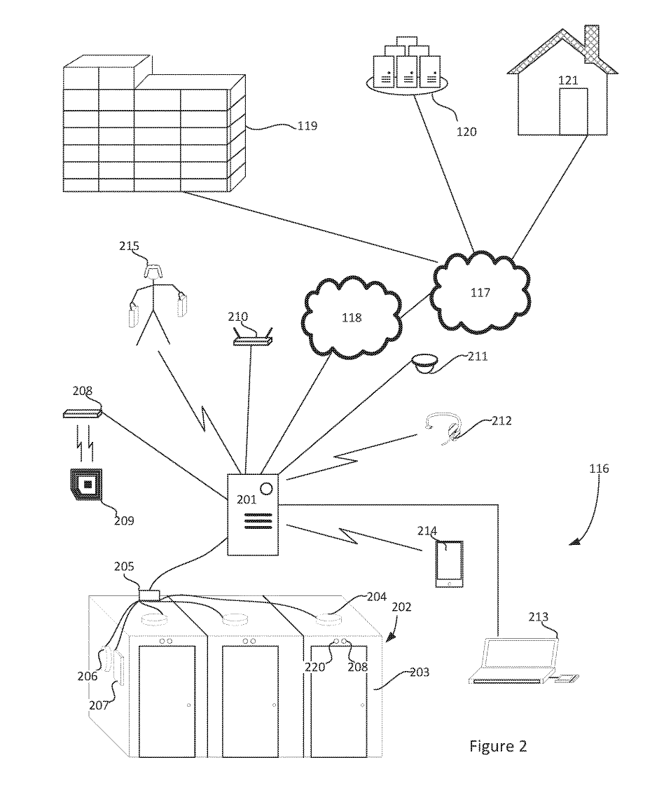

FIG. 2 illustrates an embodiment of an ICRS 116. Appreciate that IRCS 116 may include one or more additional networking components, such as routers, switches, hubs, and the like, that are not shown in FIG. 2 in the interest of brevity. Such components would be apparent to a person of skill in the art.

The IRCS 116 includes an application server, which is referred to herein as ICRS server 201. The ICRS server 201 interfaces the entities included in the ICRS 116. The ICRS server 201 can generally be any kind of application server and may be scaled based on the size of the retail outlet. A typical application server used as the IRCL 116 is a 4-6 U rackmount machine running a multi core (typically 4-10 core) processor comparable to an Intel® Xeon® 7500 series processor. An example of a suitable application server for a typical implementation is an IBM® System x3860 X5. Another example is a Dell® PowerEdge® R910.

FIG. 2 illustrates a bank 202 of changing rooms 203. Each changing room includes a changing room occupancy sensor 204 installed within the changing room 203. The changing room occupancy sensors 204 may connect with the ICRS server 201 via a switch or hub 205 or each sensor may connect directly to the ICRS server 201. Alternatively, the changing room occupancy sensors 204 may wirelessly connect to the ICRS server 201. The sensors 204 detect when a changing room 203 is occupied. For example, the sensor 204 can detect when a person enters or exits a changing room 203. For example, the sensor 204 may contain one or more infrared sensors capable of detecting the presence of a person in the changing room 203.

Each changing room 203 may include an occupancy indicator 220 for indicating whether the changing room is occupied. The occupancy indicator 220 may be a light, such as an LED, for example. When the changing room occupancy sensor 204 senses that the changing room 203 is occupied, the changing room occupancy sensor 204 may send a signal (either directly or via the ICRS server 201) turning on the occupancy indicator 220.

Each changing room 203 may contain one or more user interface (UI) devices. Two UI devices are shown in FIG. 2. One example of a UI is a simple call button 206, which a customer can use to summon a sales or changing room attendant. According to certain embodiments, each changing room may include a call indicator 208, which turns on in response to a customer activating a call button. Alternatively (or additionally), a sales or changing room attendant may be paged, either at an attendant station or via a pager or headset, in response to a customer activating the call button 206. Another example of a UI device is a graphical user interface device (GUI) 207. GUI may be a touch screen device, for example, and may enable extended customer/sales attendant interaction, as described in more detail below.

The ICRL server 201 may also be networked with radio-based sensor, such as a radio frequency identification (RFID) reader 208. One or more RFID readers may be located throughout a store and may sense RFID tags 209 attached to merchandise. Thus, the ICRS server (and possibly other store-based data systems) can track merchandise as it moves about the store based on received RFID data. According to some embodiments, an RFID reader 208 is located within the changing rooms 203 or within the general location of the changing rooms, thereby allowing the ICRS server 201 to track merchandise into and out of the changing room area. According to some embodiments, an RFID reader 208 may be integrated within the changing room occupancy sensor 204.

The ICRL server 201 may also be linked to one or more wireless access points (WAPs) 210. WAP 210 allows the ICRS server 201 to wirelessly communicate with components of the ICRL system, which are described in more detail below.

The ICRS server 201 may also be linked to one or more cameras 211. Cameras 211 may comprise part of the store's loss prevention system or may be dedicated components of the ICRS system. Cameras 211 may be positioned throughout the store to provide data allowing customer movements to be tracked. According to some embodiments, ICRS server 201 accesses the cameras 211 via the store's security subnetwork 102 (illustrated in FIG. 1).

The ICRS server 201 may also be linked to one or more attendant communication systems 212. Examples of attendant communication systems can include headphones, earpieces, pagers, and the like. ICRS server 201 may communicate wirelessly with such attendant communication systems, for example, via WAP 210. Attendant communication systems may include one or more base stations (not shown) that may be connected (wired or wirelessly) to the ICRS server 201.

The ICRS server 201 may be connected to one or more POS systems, such as POS terminals 213. Examples of POS terminals include stationary cash registers and mobile POS devices, such as payment card readers. The ICRS server 201 may have a hardwired or wireless connection to stationary POS devices and may have a wired connection to mobile POS devices. Alternatively, the ICRS server 201 may be linked to one or more POS systems by the store's network, such as via the store's POS subnetwork 103 (illustrated in FIG. 1).

The ICRS server 201 may be connected to one or more mobile devices 214. Examples of mobile devices 214 include smartphones and tablets, such as iPad® or Android®-based tablets. The mobile devices 214 may be a customer's mobile device or may be used by sales/changing room attendants (both embodiments are described in more detail below). The ICRS server 201 may connect to the mobile device 214 via a WAP 210, for example. Additionally (or alternatively), the ICRS server 201 may connect to the mobile device 214 via a cellular or other appropriate network to send text messages (short message service (SMS) or multimedia messaging service (MMS)) to the mobile device 214.

The ICRS server 201 may also communicate with a customer 215 within the store. For example, the ICRS server 201 may communicate with the customer 215 via a customer's mobile device 214, as described above. Alternatively, the ICRS server 201 may communicate with a paging device that a changing room attendant may give the customer 215. Also, the ICRS server 201 may receive data from a customer, for example, from the customer's mobile device 214. For example, the ICRS server 201 may obtain the identity of the customer 215 and information about the customer's preferences if the customer has chosen to make that information available. For example, the customer 215 may be a member of a loyalty program and may install a mobile application on their mobile device 214, making their buying history, merchandise preferences, and the like available to the ICRS server 201. Alternatively, the customer 215 may scan a loyalty identification card, allowing the ICRS 201 to associate the customer with such information about the customer.

As mentioned above, the ICRS 116 can connect to the internet 117, for example, via the communications subnetwork 118. Being connected to the internet 117, the communications subnetwork 118 or other resources of the store LAN 100 can connect to other members of the BMR enterprise, such as a home office 119 or one or more data centers 120. Data derived from the ICRS 116 may be provided to/from customers 121 via the internet. Several of the use cases described below leverage the availability of the ICRS 116 (or more specifically, the data derived therefrom) via the internet.

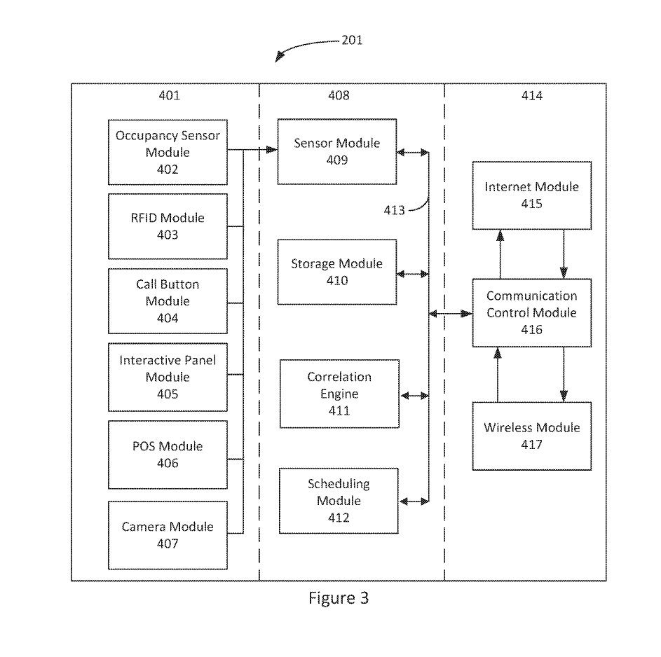

FIG. 3 shows an example of a logical arrangement of ICRS server 201. The server 201 includes a bank of one or more component interface modules 401 for interfacing with the distributed components of the ICRS 116. Examples of component interface modules (aka sensor interface modules) 401 include a changing room occupancy sensor module 402, RFID module 403, call button module 404, interactive panel module 405, POS module 406, and camera module 407. The component interface modules 401 are configured to receive data from their respective components. The modules may include ports, such as serial, parallel, USB, for communicating with their respective components and may use a standard communication protocol, such as RS-232, or a proprietary protocol.

ICRS server 201 can also contain one or more processing modules 408 for processing data received from the component interface modules 401. Examples of processing modules 408 include a sensor module 409, a storage module 410, a correlation engine 411, and a scheduling module 412. The sensor module receives and arbitrates data from the component interface modules 401. The storage module 410 can store the data received from the sensor module 409 and/or from the correlation engine 411. The correlation engine 411 can determine relationships between the data received from the sensor module 409 and/or storage module 410, as explained in more detail below. Likewise, the scheduling module 412 can schedule resources based on information received from the sensor module 409 and/or storage module 410, as explained in more detail below. The processing modules may be connected by a data bus 413. The processing modules 408 can be implemented as one or more processors, such as a CPU, programmed to carry out the steps described herein.

It should be noted that one or more of the processing modules may be located remotely. For example, in the embodiment illustrated in FIG. 3, the correlation engine 411 and the scheduling module 412 are included within ICRS server 201. However, the functions performed by one or both of those modules could be performed remotely from the ICRS server 201, for example, at a data center connected to the ICRS server 201 via the internet. It should also be noted that the storage module 410 stores data in a format appropriate for processing by the correlation module 411 and that the correlation module 411 is configured to make correlations based on data received from the sensors and/or to instruct actions based on that data. If the correlation engine is resident within the ICRS server 201 and is performing correlations in real time, the storage module 410 may be a first in first out (FIFO) storage, which can feed data to the correlation engine 411. If correlation and/or data analysis does not happen in real time, then the storage module must store data in a format suitable for later analysis. An example of such a format is comma separated variable (CSV) data. Additional data formatting is known to those of skill in the art.

The IRCS server 201 can also contain one or more communication modules 414 such as an internet module 415, communication control module 416, and wireless module 417. The communication control module 416 can exchange data with the bus 413 and communicate that data via the internet (via internet module 415) and/or via wireless communication (via wireless module 417).

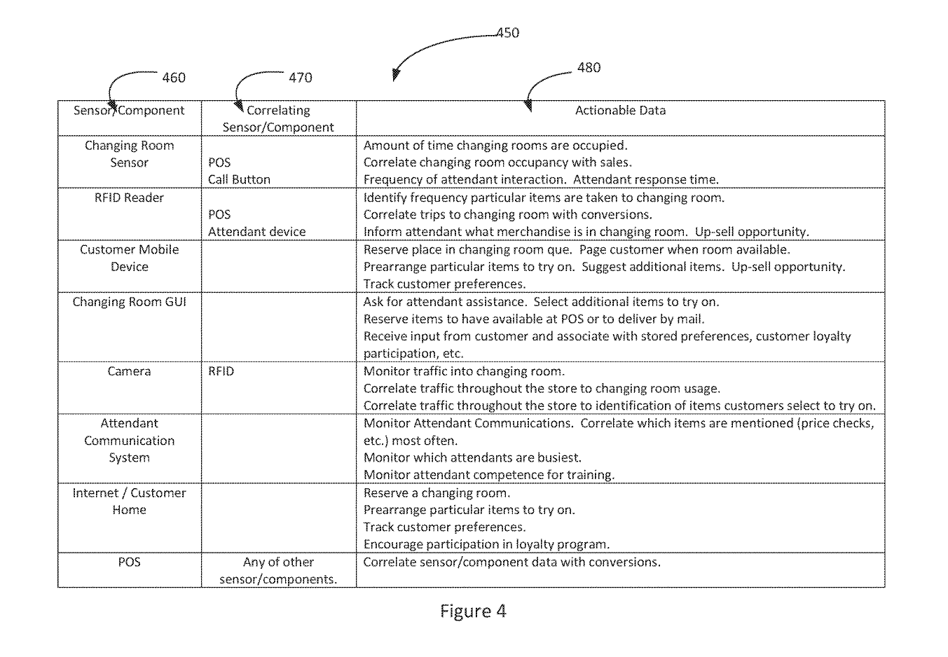

FIG. 4 is a table 450 showing examples of correlations and actionable data provided by the ICRS server 201. It should be noted that the correlations and actions listed in FIG. 4 may be performed locally at the ICRS server 201, or alternatively, may be performed off-site at a data center 119, for example. In other words, the ICRS server may collect, store, and/or transmit data to a data center. Moreover, the correlations and actions may be distributed, that is, some steps of the actions may be performed locally and other steps may be performed off-site. It should also be noted that the actions and correlations listed in FIG. 4 are only exemplary; it is within the ability of a person of skill in the art to derive additional correlations using an ICRS 116.

The first column 460 of table 450 lists a primary sensor or component of the ICRS 116. The third column 480 lists examples of the actionable data that the ICRS 116 can be derived from data from the sensor listed in column 460. In some embodiments, data from sensors listed in column 460 can be combined with data from additional sensors, such as listed in column 470 to provide additional actionable data.

As shown in FIG. 4, data from the changing room occupancy sensor 204 can indicate the amount of time changing rooms are occupied. A retailer can use that information to determine if they need to improve their efforts to encourage more changing room occupancy and also if they have adequate changing room resources. Data from the changing room occupancy sensor 204 can also be correlated with POS data to determine how changing room usage correlates to sales. Call button data can be used to determine how often customers summon a sales attendant to the changing room and how quickly an attendant responds.

Data from the RFID reader can be used to determine what items customers take to the changing rooms and, when correlated with POS data, how often those events lead to a purchase. The RFID data can also inform attendants and sales staff which items are being tried on, giving them the opportunity to suggest additional or alternative items.

According to certain embodiments, the ICRS 116 can communicate with a customer 215, for example, via the customer's mobile device. According to some embodiments, the customer may download an application to their mobile device, allowing the customer device to send/receive data to/from the ICRS 116. Using such an application, a customer can reserve a changing room or be placed in a que for a changing room and notified when on becomes available. The customer may make such a reservation while at the store, for example, via a wireless connection using WAP 210. Alternatively, a customer with access to the internet may make such reservations before arriving at the store. The customer may use an application on their mobile device (or computer) to prearrange particular items to try on at the store. With access to such a reservation, a changing room attendant can have the items waiting for the customer when the customer arrives. The changing room attendant may also suggest additional or alternative items. According to some embodiments, the ICRS 116 may track the customer's choices, determine which reservations lead to purchases, and allow direct personal marketing opportunities based on the customer's reservation and purchasing history.

According to some embodiments the ICRS server 201 can receive data from a GUI 207 in a changing room. For example, the GUI may allow the customer to request particular items to try on. The ICRS server 201 may retain that information and associate it with the customer's preferences. The GUI 207 may allow the customer to sign in, for example, if the customer is member of loyalty program. The customer may reserve items via the GUI or select to have items mailed to their residence.

According to some embodiments the ICRS server 201 may receive data from one or more cameras 211. That data can help determine the amount of traffic to the changing room and can also correlate traffic throughout the store with traffic to the changing rooms. Camera data can also be correlated to identification of the particular items taken to the changing room to determine how traffic patterns impact which items customers choose to try on. A store manager may want to optimize store traffic to encourage customers to sample higher priced items, for example.

According to some embodiments the ICRS server 201 may receive and maintain data from the attendant communication system 212. That data may be used to determine which items are mentioned most often, how often price checks are called for, etc. The data may also be used to monitor attendant performance and determine which attendants are the busiest, etc. Such data may inform how a store manager deploys attendant resources and for training purposes.

According to some embodiments the ICRS server 201 may connect to the internet and/or exchange internet data with an internet server connected to the internet. For example, the ICRS may access data derived from an application running on customer's home computer via the internet. A customer may use such an application to reserve a changing room, reserve particular merchandise to try on, etc. Such interaction allows the retailer to track customer preferences.

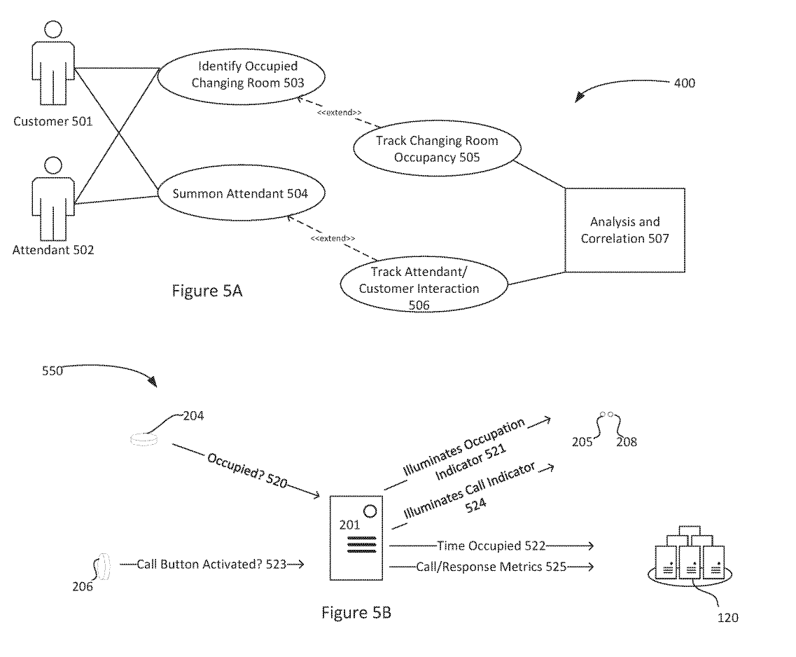

FIGS. 5A and 5B illustrate a simple use case 500 and corresponding system diagram 550, respectively, for implementing the ICRS 116. A customer 501 wishing to use a changing room can identify 503 which changing rooms are occupied/unoccupied because sensor 204 informs 520 the ICRS server 201 of the occupancy state and the ICRS server 201, in turn, causes 521 the indicator light 220 to illuminate accordingly. The ICRS server 201 can also inform 522 a data center 120 of the amount of time the changing rooms are occupied, allowing the data center 120 to track metrics 505 concerning changing room occupancy. Communication between the ICRS server 201 and the data center 120 (or other BMR enterprise center) can be facilitated by the store's LAN 118 and the internet 117. Occupancy information may be sent to the data center 120 in real time or may be stored locally and uploaded/transferred periodically.

A customer 501 may summon 504 an attendant 502 by activating the call button 206. When the ICRS server 201 senses 523 that the call button has been activated the ICRS server 201 can cause 524 the call indicator 208 to illuminate. When an attended responds and resets the call indicator 208, the ICRS server 201 can turn off the call indicator 208. The ICRS server can transmit 525 data to the data center 120 concerning the number of attendant calls, the response time, etc. The BMR can use those analytics to inform attendant training and staffing issues. Integrating data from the POS terminal 213 into the ICRS allows changing room occupancy, response times, etc., to be correlated with sales. Also, the identification of the particular merchandise taken to the changing room can be identified using RFID tags and readers 209 and 208, respectively. Again, that data can be correlated with conversions (i.e., sales) using POS terminal 213 data, for example.

While the invention herein disclosed has been described in terms of specific embodiments and applications thereof, numerous modifications and variations could be made thereto by those skilled in the art without departing from the scope of the invention set forth in the claims.

What is claimed is:

1. An integrated changing room system server, comprising:
one or more sensor interface modules each configured to receive data from one or more sensors, and
a storage configured to store data received from the one or more sensors.

2. The server of claim 1, wherein the one or more sensors are selected from the group consisting of changing room occupancy sensors, RFID readers, cameras, and call buttons.

3. The server of claim 1, further configured to communicate with an internet.

4. The server of claim 1, further configured to communicate with a wireless access point (WAP)

5. The server of claim 1, further configured to communicate with a point of sale (POS) device.

6. The server of claim 1, further comprising a correlation engine configured to correlate relationships between data received from two or more of the sensors.

7. An integrated changing room system, comprising:
an integrated changing room system server, and
one or more sensors connected to the integrated changing room system server.

8. The system of claim 7, wherein the one or more sensors are selected from the group consisting of changing room occupancy sensors, RFID readers, cameras, and call buttons.

9. The system of claim 7, wherein the sensor comprises a changing room occupancy sensor.

10. The system of claim 9, wherein the changing room occupancy sensor comprises an infrared detector.

11. The system of claim 9, wherein the integrated changing room system server is configured to determine changing room occupancy time.

12. The system of claim 11, wherein the integrated changing room system is further configured to correlate changing room occupancy time with purchases.

13. The system of claim 7, wherein the sensor is an RFID reader.

14. The system of claim 13, wherein the changing room system server is configured to identify merchandise present in the changing room.

15. The system of claim 14, wherein the changing room system server is further configured to correlate purchases to the identification of merchandise present in the changing room.
